(19) United States
(12) Patent Application Publication
(10) Pub. No.: US 2023/0226728 A1
(43) Pub. Date: Jul. 20, 2023

(54) Field Joint Coating Injection Machine and Method

(71) Applicant: RAE Energy, Inc., Katy, TX (US)

(72) Inventor: Craig Leslie Burke, Theodore, AL (US)

(21) Appl. No.: 17/578,805

(22) Filed: Jan. 19, 2022

(51) Int. Cl. B29C 45/14; B29C 45/72

(52) U.S. Cl. CPC B29C 45/14622; B29C 45/14614; B29C 45/7207; B29L 2031/24

(57) ABSTRACT

A machine is disclosed for coating field joints of pipeline with a coating material. The machine includes an extruder, at least one accumulator, a mold, and pipework. The extruder is configured to melt the coating material into a molten coating material, and the at least one accumulator is configured to store the molten coating material. The mold is configured to fit around the field joints and is configured to mold the molten coating material to harden about the field joints. The pipework connects the extruder to the at least one accumulator and connects the at least one accumulator to the mold. The pipework is configured to conduct the molten coating material along the pipework. At least one heater has a fluid medium and is configured to heat the fluid medium to at least one temperature setpoint. Conduit work connects the at least one heater to the pipework and is configured to conduct the heated fluid medium with the pipework to keep the coating material molten in the pipework.

### BACKGROUND OF THE DISCLOSURE

Oil and gas pipelines are typically coated for corrosion and impact resistance and for thermal insulation. Individual pipes can be coated in a factory with an extrusion coating. The ends of the individual pipes are left bare of coating or machined back post-manufacture to produce a cutback region so the ends of the pipes can be welded together to produce the pipeline. The ends are typically joined in the field or close to the installation point. The cutback regions of the coating typically have a chamfer so the pipes can be handled without damaging edges of the coating and to increase the surface area for field joint application.

To complete the protection of the joined pipes, additional coating material is applied in the field to the cutback region at the field joints between joined pipes. Different coatings can be used for field joints, including shrink-applied casings, or cast or injection molded coatings.

To cover the field joints, for example, a field joint coating injection machine can be used in the field to cover the field joints with injection-molded material. Using this machine, a mold is placed around an exposed field joint between the cutback regions in the existing coatings of the two pipes. A coating material, such as polypropylene, is heated and kept molten within the field joint coating injection machine. The melted coating material is then injected into the mold to fill the space around the field joint. Once the material has cooled around the joint enough, the mold is removed, leaving a coating that covers across the field joint.

During operation, the coating material is heated and kept molten in the field joint coating injection machine. To do this, mica or electric band heaters are placed around various parts of the pipework in the machine, and a number of zonal temperature sensors (thermocouples) are used to measure the temperatures to ensure that the material is kept molten. The electric heating by the band heaters may not provide uniform heating, and a number of heating zones need to be controlled and monitored. These band heaters are electrically powered and have limited power output for particular zones. The band heaters are susceptible to physical damage, can burn out, and require additional on-machine wiring for the various zones to be heated on the machine. Additionally, faulty thermocouples may send inaccurate temperature readings that cause the conventional electric band heaters to increase power and increase temperature unchecked.

Unfortunately, current industry practice has dealt with the failings of the present arrangement by increasing the number of temperature sensors used throughout the machine to redundantly monitor for temperature issues or failures of the electric band heaters.

The subject matter of the present disclosure is directed to overcoming, or at least reducing the effects of, one or more of the problems set forth above.

### SUMMARY OF THE DISCLOSURE

A machine is disclosed herein for coating a portion of a pipeline with a coating material. The machine comprises an extruder, a coater, pipework, at least one fluid heater, and conduit work. The extruder is configured to melt the coating material into a molten coating material, and the coater is configured to fit on the portion of the pipework and is configured to coat the molten coating material thereon. The pipework connects the extruder to the mold, and the pipework is configured to conduct the molten coating material therealong. The at least one fluid heater has a fluid medium and is configured to heat the fluid medium to at least one temperature setpoint. The conduit work connects the at least one fluid heater to the pipework and is configured to conduct the heated fluid medium with the pipework.

A machine is also disclosed herein for coating field joints of pipeline with a coating material. The machine comprises an extruder, at least one accumulator, a mold, pipework, at least one fluid heater, and conduit work. The extruder is configured to melt the coating material into a molten coating material, and the at least one accumulator is configured to store the molten coating material. The mold is configured to fit around the field joints and is configured to mold the molten coating material to harden about the field joints. The pipework connects the extruder to the at least one accumulator and connects the at least one accumulator to the mold. The pipework is configured to conduct the molten coating material therealong. The at least one fluid heater has a fluid medium and is configured to heat the fluid medium to at least one temperature setpoint. The conduit work connects the at least one fluid heater to the pipework and is configured to conduct the heated fluid medium with the pipework.

A method of processing an exposed field joint of a pipeline is disclosed herein. The method comprises: melting a coating material in an extruder; accumulating the melted coating material in at least one accumulator; injection molding the melted coating material in a mold fit around the exposed field joint; conducting the melted coating material from the extruder, to the accumulator, and to the mold using pipework; and maintaining the coating material melted in the pipework by heating a fluid medium and conduiting the heated fluid medium into heat transfer with the pipework.

The foregoing summary is not intended to summarize each potential embodiment or every aspect of the present disclosure.

### BRIEF DESCRIPTION OF THE DRAWINGS

FIG. 1 illustrates a schematic view of a field joint coating injection machine according to the present disclosure.

FIG. 2 illustrates an example section of pipework for the machine having conduit work for conducting heated fluid medium.

FIG. 3 illustrates an example section of conduit work for the machine connected to a heater.

FIG. 4 illustrates a schematic view of another field joint coating injection machine according to the present disclosure.

FIG. 5 illustrates a flowchart for temperature control in a machine according to the present disclosure.

FIG. 6 illustrates a schematic view of a field joint coating injection machine according to another configuration of the present disclosure.

FIG. 7 illustrates a schematic view of a pipe coating machine according to the present disclosure.

### DETAILED DESCRIPTION OF THE DISCLOSURE

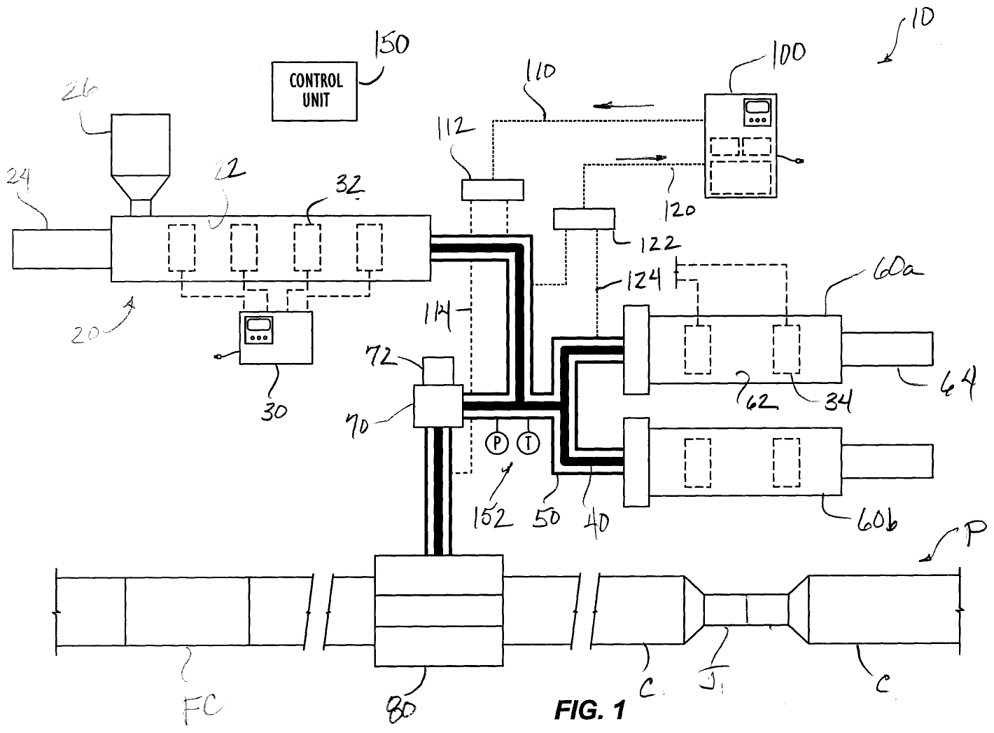

FIG. 1 illustrates a schematic view of a field joint coating injection machine 10 according to the present disclosure. As its name implies, the machine 10 is used for coating field joints J of a pipeline P with a coating material to produce field coatings FC. The machine 10 includes an extruder 20, at least one accumulator 60a-b, a coater 80, and pipework 40. The pipework 40 interconnects the extruder 20, the at least one accumulator 60a-b, and the mold 80 together so that molten coating material that is produced by the extruder 20 and is stored in the accumulator 60a-c can be injection molded by the mold 80 to a field joint J.

The extruder 20 is configured to melt the coating material, such as polypropylene, into a molten coating material. The extruder 20 has a barrel or chamber 22 to process the coating material. For example, solid pellets of the coating material can be fed into the barrel 22 by a hopper 26. A feeder 24, such as a screw, processes the raw coating material through the barrel or chamber 22. As shown in this configuration, the extruder 20 uses electric heating elements 32 to aid in heating the coating material in barrel or chamber 22. At least one electric heating unit 30 can be used to power and control the electric heating elements 32 so that the heating elements 32 assist in melting the material being extruded along the extruder 20 to a proper melting temperature.

Here, the coater 80 is a mold, and at least one accumulator 60a-b is configured to store quantities of the molten coating material for eventual injection molding with the mold 80. As shown here, a pair of accumulators 60a-b can be used. Each accumulator 60a-b includes a chamber 62 for storing the molten coating material and has a feeder 64, such as a piston, to force the material out of the chamber 62. A valve 70 disposed on the pipework 40 between at least one accumulator 60a-b and the mold 80, controls delivery of the molted coating material from the accumulators 60a-b to the mold 80. For example, the valve 70 can include a hydraulic piston or other actuator 72 that is operable to open and close communication of the molten coating material therethrough so that the material forced from the accumulator 60a-b can enter the mold 80 closed around the field joint J of the pipeline P.

The mold 80 is configured to fit around the field joint J and is configured to mold the molten coating material about the field joint J. As is typical, the mold 80 includes two or more articulating mold sections that can be moved using hydraulics or the like to fit around the field joint J.

The pipework 40 connects the extruder 20 to the at least one accumulator 60a-b and connects the at least one accumulator 60a-b to the mold 80, and the pipework 40 is configured to conduct the molten coating material therealong. As is typical, the pipework 40 includes one or more pipes, pipe sections, etc. that are connected by flanges or the like. The pipework 40 is typically composed of steel and can be of an appropriate diameter in which to conduct the proper throughput of the coating material for performing the injection molding.

During operations, the pipeline P to be coated remains stationary whilst the machine 10 is moved into position about the field joint J at the open mold 80. Pellets of coating material that are vacuum fed into material hopper 26 on the extruder 20 can be mixed with various additives. The extruder 20 processes the mixed material into a molten form by screw feeding the pellets at pressure along the heated barrel 22 of the extruder 20. The molten material is fed along the pipework 40 to the accumulators 60a-b filling the accumulators through the act of process material through the extruder.

The machine 10 is moved so that the mold 80 is centered at the field joint J to be coated. The mold 80 is then raised up and closed around the field joint J. Typically, the mold 80 is clamped closed with hydraulic cylinders to create a tight annulus for the injection-molded material to fill. The hydraulically-operated valve 70 is opened, and the feeder 64 of an accumulator 60a-b forces the molten material out of the accumulator's chamber 62 so the material can be injected into the mold 80 and can encase the field joint J. Cooling allows the material to harden inside the mold 80. For example, chilled fluid can be used to cool at least the outer profile of the material. The mold 80 can be opened, and the cast-filled joint F can be further cooled and dressed. This process is repeated along the pipeline P at the various field joints J.

Between coating steps, the coating material is kept heated and molten. Thus, the at least one accumulator 60a-b uses electric heating elements 34 to heat the coating material stored therein. The electric heating unit 30 can be used to power and control the electric heating elements 34 so that the heating elements 34 keep the material molten.

The coating material inside the pipework 40 must also be kept molten during operations. Inadvertent cooling of the material during operations can be hazardous. To uniformly heat the molten coating material in the interconnecting pipework 40, the machine 10 includes at least one fluid heater 100 having a fluid medium and includes conduit work 50, connecting lines 110, 114, 120, 124, and manifolds 112, 122 to conduct the heated fluid medium. The fluid heater 100 is configured to heat the fluid medium, such as oil, to at least one temperature setpoint suited to keep the coating material molten in the pipework 40. The connecting lines 110, 114, 120, 124 and the manifolds 112, 122 connect the fluid heater 100 to the conduit work 50. In turn, the conduit work 50 is configured to conduct the heated fluid medium with the pipework 40 so the heat from the fluid medium can be transferred to the coating material inside the pipework 40.

In general and as discussed in more detail below, the conduit work 50 includes one or more annular pipe sections disposed about one or more sections of the pipework 40 and defining an annular space therewith. The conducting lines 110, 114, 120, 124 are connected between the fluid heater 100 and the one or more annular pipe sections of the conduit work 50 to conduct the heated fluid medium between the fluid heater 100 and the annular space around the pipework 40.

Preferably, a delivery line 110 from the fluid heater 100 that delivers the heated fluid medium to a manifold 112, which distributes the medium to distributed conducting lines 114 that connect to the conduit work 50. In a similar manner, a return line 120 connected to the fluid heater 100 receives the fluid medium from a manifold 122, which connects by distributed conducting lines 124 from the conduit work 50. In this way, the heated fluid medium can be circulated and continuously heated to maintain a temperature setpoint throughout.

As can be seen during operations, the fluid heater 100 supplies the heated fluid medium, e.g., oil, to the pipework 40 by way of the lines 110, 120, manifolds 112, 122, and the connecting lines 114, 124 in a closed-loop system. The heated fluid medium controls the temperature of the coating material inside the pipework 40. As discussed herein, a pipe-in-pipe arrangement can transfer the heat from the heated fluid medium circulating in the conduit work 50 around the pipework 40 to achieve a uniform heat profile. Connections in the pipework 40, such as where flanged connections are present, can use an interconnecting line to connect sections in series. Of course, independent connection points from the manifolds 112, 112 can be used to connect directly to individual sections of the conduit work 50.

As shown in FIG. 1, the machine 10 can include a control unit 150 for coordinating the overall operation of the machine 10. The control unit 150 can be in communication with the extruder 20, the at least one accumulator 60a-b, the mold 80, the at least one fluid heater 10, and the at least one electric heating unit 30. As such, the control unit 150 can include some of the conventional controls and features used in a field joint coating machine to operate the extruder 20, the electric heating unit 30, the accumulators 60a-b, the valve 70, and the mold 80. In addition to these conventional controls and features, the control unit 150 is further configured to coordinate the operation of these elements in conduction with the control of the at least one fluid heater 100 and any sensing components 152 associated therewith.

As shown, one or more temperatures sensors 152 (T) can be disposed about the pipework 40 and connected to the control unit 150 to measure temperature. The control unit 150 can monitor the temperature of the molten coating material in the pipework 40 and can measure the temperature of the heated fluid medium of the conduit work 50. Various temperatures sensors 152 (T) can be appropriately distributed throughout various zones of the pipework 40 and conduit work 50 to maintain proper temperature monitoring. Because the conduit work 50 and the fluid heater 100 can provide bulk heating across a greater surface area of the pipework 40, the complexity involved in temperature monitoring can be simplified because heating is less likely to fail at discrete points in the configuration.

Other sensors can be disposed about the pipework 40 and the conduit work 50. For example, one or more pressure and/or flow sensors 152 (P) can be disposed about the conduit work 50 and connected to the control unit 150 to measure pressure and/or flow of the heated fluid medium. The pressure and/or flow measurement can be used for a variety of purposes, such as determining internal pipework pressure and subsequently blockages, etc.

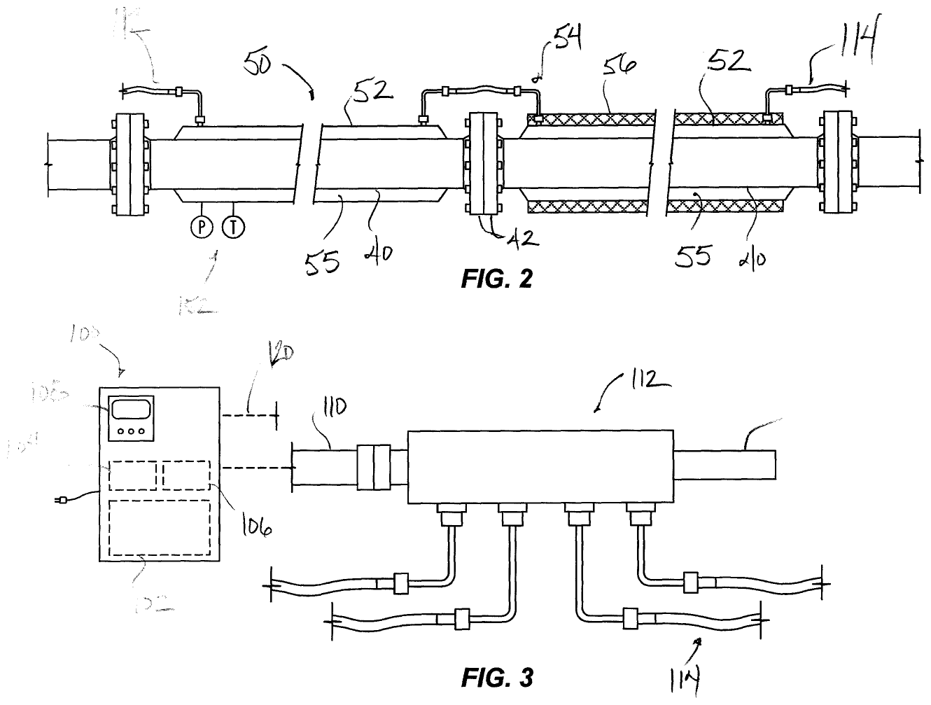

FIG. 2 illustrates an example section of pipework 40 for the machine having conduit work 50 for conducting heated fluid medium. As noted above and as shown, the pipework 40 typically includes one or more pipes, pipe sections, etc. that are connected by flanges or the like. The pipework 40 is typically composed of steel and can be of an appropriate diameter. It will be appreciated that the teachings of the present disclosure can be used for different configurations for the pipework 40.

The conduit work 50 includes annularly arranged pipe sections 52 disposed on the pipework 40. The pipe sections 52 have closed ends to form an enclosed annulus 55 with the pipework 50 for collection of the heated fluid medium. For example, the pipe section 52 can be a shorter length of tubing that fits over the pipework section and that has its ends welded to the pipework 40. Flanges 42 of the pipework 40 may be left accessible for assembly and maintenance. Of course, other forms of heat exchange can be used. For example, the conduit work 50 can include coiled tubing routed and wrapped about the pipework 40. These and other configurations can be used, and enhancements can be made to increase heat transfer rates.

Interconnecting lines 54 can connect the enclosed annuli 55 from one pipe section 52 to the other. This provides flexibility in the assembly and arrangement of the pipework 40 and the conduit work 50. The interconnected lines 54 and annuli 55 connect to the delivery line 112 for delivery of the heated fluid medium and connect to the return line 114 for return of the medium. Sizing of the lines 54, 112, 114 and volume of the annuli 55, and the like can be configured for the flow of the fluid medium and the temperature setpoints to be maintained.

The heated fluid medium in the annuli 55 can transfer heat to any molten coating material held inside the pipework 40. Additional insulation 56 can be applied to the conduit work 50 for further heat retention. The insulation 56 can extend over the flanges 42 and any exposed portions of the pipework 40 as well. If desired, temperatures and pressure sensors 152 (T, P) can be associated with the conduit work 50 to measure pressure and temperature for the purposes of control as noted herein.

FIG. 3 illustrates an example section of the conducting lines for the machine connected to a fluid heater 100. In general, the fluid heater 100 includes a fluid reservoir 102, a heating element 104, a pump 106, and a controller 108, among other components. The controller 108 includes a temperature sensor configured to measure the temperature of the heated fluid medium. The pump 106 pumps the fluid medium, and the heating element 104, which is preferably electric, heats the fluid medium. During operation, the controller 108 is configured to operate the electric heating element 104, and the pump 106 based on the measurements so the fluid medium can be properly heated. A chilled water supply is connected to the fluid heater 100 in order to regulate the temperature should it be required.

As shown in FIG. 3, an example of a manifold 112 for the delivery line 110 from the fluid heater 100 is shown. The manifold 112 connects to the larger delivery line 110 from the fluid heater 100 and distributes the heated fluid medium to a plurality of conducting lines 114, which can be hydraulic lines or the like. The arrangement for the return line 120 of the heater 100 can be similarly arranged. The delivery line 110, the manifold 112, and the conducting lines 114 can be insulated.

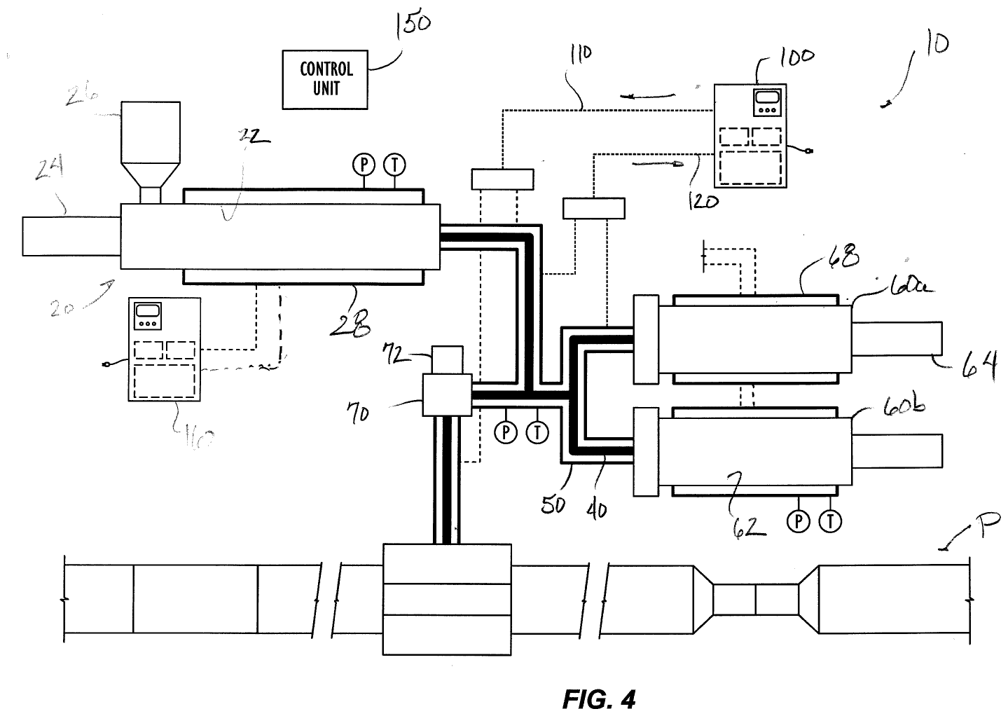

FIG. 4 illustrates a schematic view of another field joint coating injection machine 10 according to the present disclosure. This machine 10 is similar to that discussed above so like reference numerals are used for comparable components.

In the previous arrangement, electric heating was applied directly to the extruder 20 and the accumulators 60a-b. In the present arrangement, a heated fluid medium is used for heating the extruder 20 and accumulators 60a-b as well as being used for heating the pipework 40.

As before, the conduit work 50 connects to at least one fluid heater 100 so heated fluid medium can be used to heat the coating material in the pipework 40 to keep it molten. Features of this arrangement can be similar to those discussed above and are not repeated here.

The extruder 20 includes conduit work 28 for heated fluid medium to be used in heating and melting the coating material for the extruder 20. Likewise, the accumulators 60a-b include conduit work 68 for heated fluid medium to be used in keeping the coating material molten in the accumulators 60a-b. As shown, the additional conduit work 28, 68 can be connected to one or more additional fluid heaters 160, if necessary, so that separate temperature setpoints can be maintained between the extruder 20, the accumulators 60a-b, and the conduit work 50. As such, the control unit 150 can separately control the fluid heaters 100, 160 for the extruder 20, the accumulators 60a-b, and the conduit work 50. Of course, one fluid heater could be used if appropriate. Moreover, the extruder 20 and the accumulators 60a-b can use separate fluid heaters different from the conduit's fluid heater 100; or the accumulators 60a-b and the conduit work 50 can share the fluid heater 100 separate from the fluid heater 160 used for the extruder 20.

In general, the additional conduit work 28, 68 can include annular spaces surrounding a housing or chamber 22, 62 of the respective components 20, 60 so heat from the heated fluid medium can be transferred to the coating material inside the respective chamber 22, 62. Other forms of heat exchange can be used. For example, the conduit work 28, 68 can include coiled tubing routed and wrapped about the housings or chambers 22, 62. These and other configurations can be used, and enhancements can be made to increase heat transfer rates.

As disclosed herein, the configuration for the machine 10 simplifies the heating used to keep the coating material molten in the pipework 40. The need to control multiple, individually heated zones is simplified or avoided. Instead, unitary heat source(s) from the fluid heater(s) 100, 160, etc. can provide a much more uniform and desirable heat profile to more of the pipework 40 (and other parts of the machine 10 if applicable). The configuration for the disclosed machine 10 also mitigates potential safety hazards that can be caused by faulty thermocouples. Heat retention can be much improved in the disclosed machine 10 due to the physical mass of the heated fluid medium acting as an additional heated insulation layer around the material pipework 40. Ease of manufacture is also greatly increased due to simpler wiring and routing required of the component as well as ease in locating faults should any issue occur.

Based on the understanding above, the operation of the disclosed configurations can have a more simplified process flow because the fluid heater(s) takes care of the primary temperature control in the machine 10.

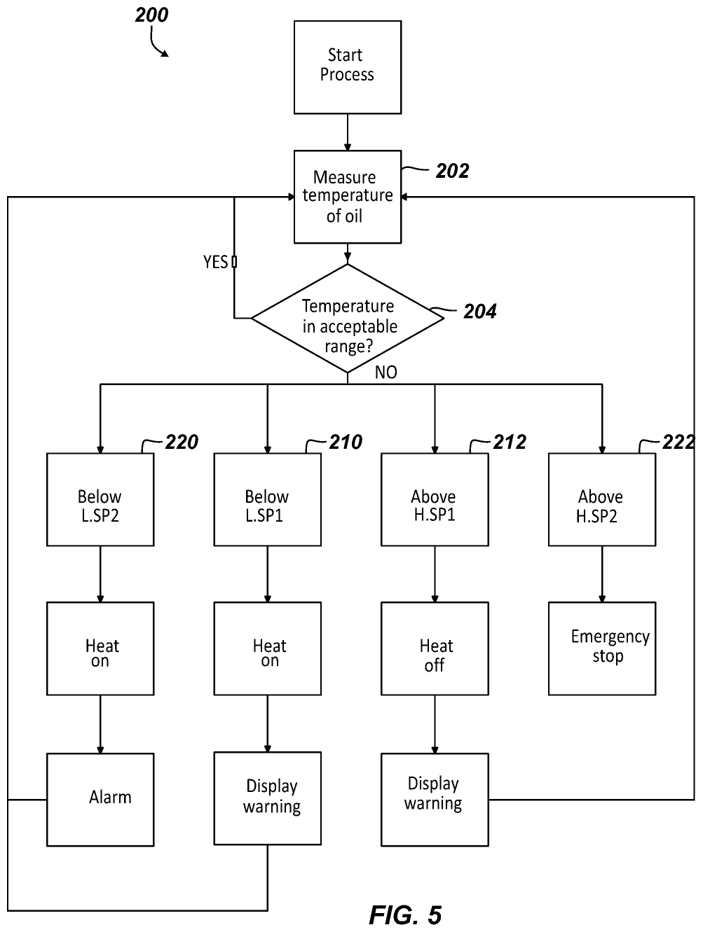

FIG. 5 illustrates a flowchart of a process 200 for temperature control in a machine (10) according to the present disclosure. Reference to elements in other figures is made for better illustration. The process 200 for temperature control shown here does not include any processing controls directly related to operating components of the machine 10, such as running the extruder 20, opening/closing the mold 80, operating the accumulators 60a-b, opening/closing the valve 70, etc. As will be appreciated, a control system (e.g., one or more control units 150, one or more controllers 108, or the like) as disclosed herein can be used for the temperature control and any other control functions.

At the start of the process 200, the control system can measure the temperature of the heated fluid medium (oil) (Block 202). The measurements can include temperatures measured in the fluid heater 100, 160, etc., and can include one or more temperatures measured with one or more sensors 152 distributed in the conduit work 50. Based on the coating material used and other factors, the temperature for the heated fluid requires a particular acceptable range in order for the heated fluid to keep the coating material molten. Therefore, the control system determines whether the measured temperature is within the acceptable range (Decision 204). If so, then the control system can return to monitoring temperature measurements (Block 202), which may be performed on a cyclical basis.

When the measured temperature is not within the acceptable range, then the control system performs one of a number of actions depending on the discrepancy. As shown here, the acceptable temperature range can have sets of low and high setpoint values to which temperature measurements can be compared. Extreme setpoints (L.SP2, H.SP2) represent an outer boundary for the temperature range, and inner setpoints (L.SP1, H.SP1) represent an inner range between which proper temperature values can lie.

Therefore, the control system can maintain current heating by the heating element 104 and current pumping by the pumping element 106 of the heater 100 when the temperature measurements are within the inner set points. If the temperature falls below the lower inner setpoint (L.SP1) (Block 210), the control system turns on the heat supplied by the heating element 104. If the heating element 104 is already powered, then the power can be increased. If appropriate, changes in the flow of the heated fluid can also be implemented using the pumping element 106. A warning may also be displayed or communicated, and the control system returns to measuring the temperature (Block 202) to determine if and when the temperature measurements increase to the acceptable range (Block 204).

If the temperature falls below the lower outer setpoint (L.SP1) (Block 220), the control system turns on the heat supplied by the heating element 104. If the heating element 104 is already powered, then the power can be increased. If appropriate, changes in the flow of the heated fluid can also be implemented using the pumping element 106. An alarm may also be displayed or initiated, and the control system returns to measuring the temperature (Block 202) to determine if and when the temperature measurements increase to the acceptable range (Block 204). Shut off of machine functions may or may not follow.

In like manner, if the temperature rises above the high inner setpoint (H.SP1) (Block 212), the control system turns off the heat supplied by the heating element (or reduces the power supplied to the heating element). If appropriate, changes in the flow of the heated fluid can also be implemented using the pumping element 106. A warning may also be displayed or communicated, and the control system returns to measuring the temperature (Block 202) to determine if and when the temperature measurements decrease to the acceptable range (Block 204).

If the temperature rises above the high outer setpoint (H.SP2) (Block 222), the control system initiates an emergency shut down to stop the operation of the machine to avoid elevated temperatures.

As can be seen, the monitoring process 200 performed here is made directly to the heated fluid medium, which under the configuration of the disclosed system is arranged to transfer heat to the coating material in the pipework 40. Thus, appropriate heating of the heated fluid can be equated directly to appropriate heating of the coating material. The entire process 200 can be supplemented with additional monitoring. For example, some zonal temperature monitoring of the heated fluid, the pipework 40, the conduit work 50, and/or the coating material can be performed using distributed sensors 152 to detect temperature variation, possible anomalies, or discrepancies. For example, the monitoring process 200 can monitor the temperature of the molten coating material directly (rather than or in addition to monitoring the heating fluid) to control the temperature of the heating fluid.

The machine 10 as disclosed herein can be used for mainline production and can be permanently installed on a production line. The pipeline P can be moved for mainline production. Alternatively, the machine 10 can be implemented as a mobile unit that can be moved to locations. Moreover, in some embodiments, components of the machine 10 can be separated from other components so the separated components can be moved to a field joint.

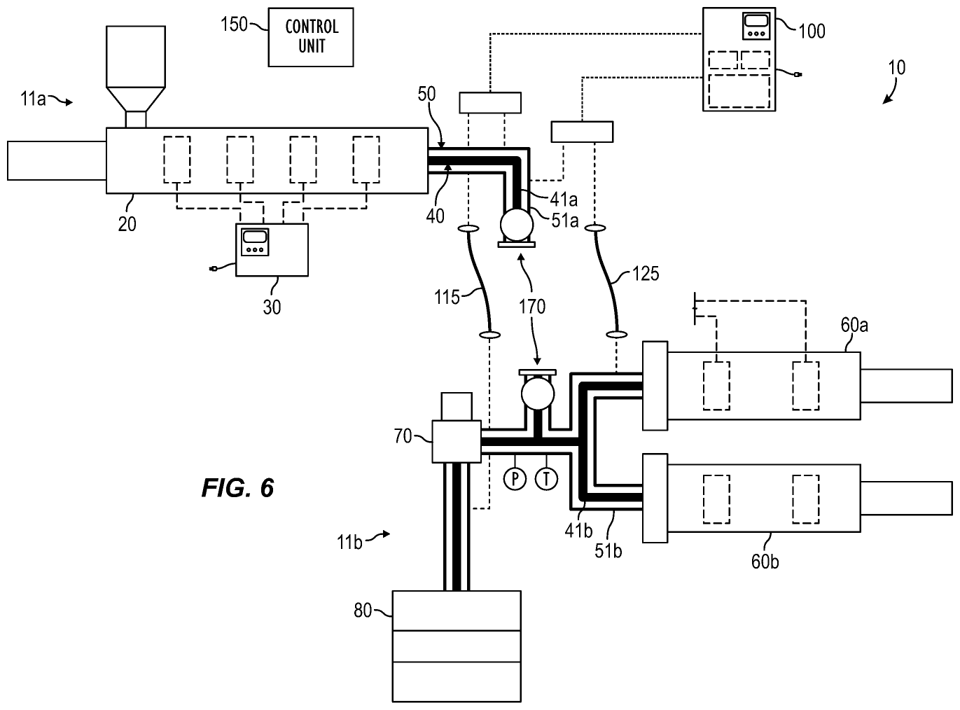

For example, FIG. 6 illustrates a schematic view of a field joint coating injection machine 10 according to another configuration of the present disclosure. Like reference numerals are used for comparable components to other embodiments. Again, the coater 80 is a mold, and at least one accumulator 60a-b is configured to store quantities of the molten coating material for eventual injection molding with the mold 80.

Here, the accumulator 60a-b and the mold 80 are separable as a movable unit 11b from the extruder 20, which is typically a large and heavy component. In this way, the extruder 20 along with its heater 30 can be a unit 11a used to melt the coating material, which can be communicated to the accumulators 60a-b. The accumulators 60a-b and mold 80 can then be disconnected from the pipework 40 of the extruder 20 so the movable unit 11b having the accumulators 60a-b and mold 80 can be moved as using a lift or the like to a field joint to be coated.

In this embodiment, the conduit work 50 of the present disclosure is used on the pipework 40 as before. However, a connection and valve arrangement 170 can be used between the pipework 40 to allow a section 41a of the pipework 40 for the extruder 20 to be separated from another section 41b of the pipework 40 for the accumulators 60a-b and mold 80. The conduit work 50 can also be divided at the connection and valve arrangement 70 so a section 51a of the conduit work 50 for the extruder 20 can be separated from another section 51b of the conduit work 50 for the accumulators 60a-b and mold 80. If practical, the same heating unit 100 can connect to both of the sections 51a-b of the conduit work 50. For example, flexible lines 115, 125 of an umbilical (not shown) can be used for connecting to the movable unit's conduit work 51b so the movable unit 11b can be moved. Alternatively, each conduit section 51a-b can have its own heating unit 100 such that one unit 100 stays with the extruder's conduit work section 51a and the other heating unit (not shown) can be moved with the movable unit 11b to heat its conduit work section 51b.

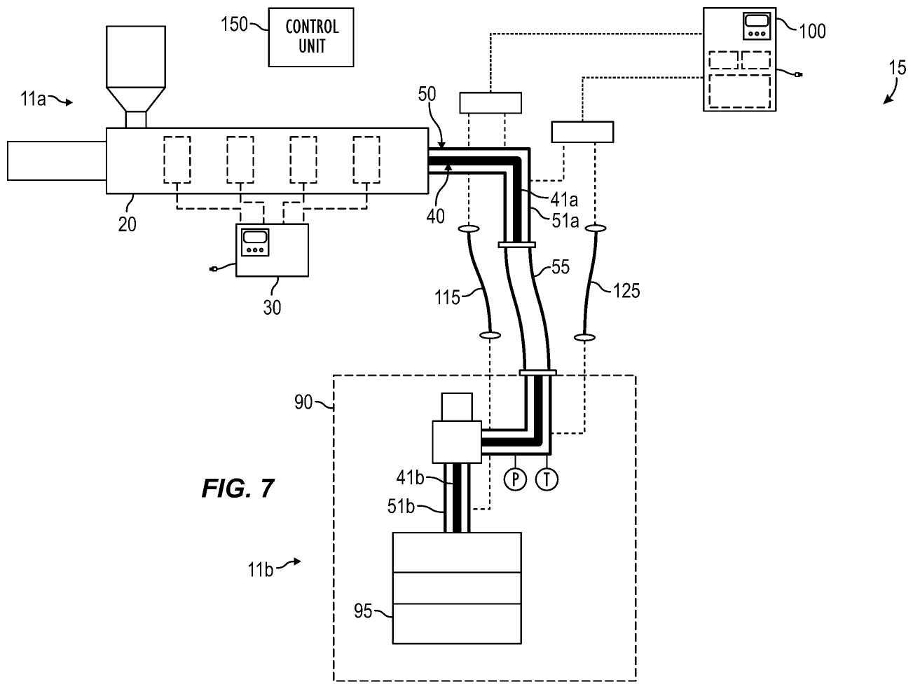

The teachings of the present disclosure can also be used with machines other than a field joint coating injection machine. For example, a coating machine can be used to coat the surface of a pipe with a thin coating. For example, FIG. 7 illustrates a schematic view of a pipe coating machine 15 according to the present disclosure. As before, the machine 15 can be a mainline production unit or can be a smaller more mobile unit. The machine 15 includes an extruder 20, pipework 40, and a coater 90, along with other supporting components. Here, the coater 90 is a robotic assembly having a die head 95 that installs on a pipe (not shown). Rotation of the die head 95 about the pipe by the robotic assembly 90 wraps extruded coating material around a field joint or the like.

For this machine 15, the robotic assembly 90 is separable as a movable unit 11b from the extruder 20, which is typically a large and heavy component. In this way, the extruder 20 along with its heater 30 can be a unit 11a used to melt the coating material. The movable unit 11b having the robotic assembly 90 can then be moved using a lift or the like to a field joint to be coated. (For a mainline production unit, components of the machine 15 do not need to be disconnected from the extruder 20.)

In this embodiment, the conduit work 50 of the present disclosure is used on the pipework 40 as before. However, a connection, such as an umbilical 55, can be used between the pipework 40 to allow a section 41a of the pipework 40 for the extruder 20 to be separated from another section 41b of the pipework 40 for the robotic assembly 90. The conduit work 50 can also be divided. For example, the robotic assembly 90 includes integrated pipework sections 41b for conducting the heated coating material. A section 51a of the conduit work 50 for the extruder 20 can be separated from another section 51b of the conduit work 50 for the assembly 50. If practical, the same heating unit 100 can connect to the sections 51a-b of the conduit work 50. For example, flexible lines 115, 125 of the umbilical 50 can be used for connecting to the movable unit's conduit work 51b so the movable unit 11b can be moved. Alternatively, each conduit section 51a-b can have its own heating unit 100 such that one unit 100 stays with the extruder's conduit work section 51a and the other heating unit (not shown) can be moved with the movable unit 11b to heat its conduit work section 51b.

The foregoing description of preferred and other embodiments is not intended to limit or restrict the scope or applicability of the inventive concepts conceived of by the Applicants. It will be appreciated with the benefit of the present disclosure that features described above in accordance with any embodiment or aspect of the disclosed subject matter can be utilized, either alone or in combination, with any other described feature, in any other embodiment or aspect of the disclosed subject matter.

In exchange for disclosing the inventive concepts contained herein, the Applicants desire all patent rights afforded by the appended claims. Therefore, it is intended that the appended claims include all modifications and alterations to the full extent that they come within the scope of the following claims or the equivalents thereof.

What is claimed is:

1. A machine for coating a portion of a pipeline with a coating material, the machine comprising:
an extruder being configured to melt the coating material into a molten coating material;
a coater being configured to fit on the portion of the pipework and being configured to coat the molten coating material thereon;
pipework connecting the extruder to the mold, the pipework configured to conduct the molten coating material therealong;
at least one fluid heater having a fluid medium and being configured to heat the fluid medium to at least one temperature setpoint; and
conduit work connecting the at least one fluid heater to the pipework and being configured to conduct the heated fluid medium with the pipework.

2. The machine of claim 1, wherein the coater comprises:
a mold being configured to fit around the portion of the pipework and being configured to mold the molten coating material to harden about the portion; or
a die head being configured to fit adjacent the portion of the pipework and being configured to layer the molten coating material to harden about the portion.

3. A machine for coating field joints of pipeline with a coating material, the machine comprising:
an extruder being configured to melt the coating material into a molten coating material;
at least one accumulator being configured to store the molten coating material;
a mold being configured to fit around the field joints and being configured to mold the molten coating material to harden about the field joints;
pipework connecting the extruder to the at least one accumulator and connecting the at least one accumulator to the mold, the pipework configured to conduct the molten coating material therealong;
at least one fluid heater having a fluid medium and being configured to heat the fluid medium to at least one temperature setpoint; and
conduit work connecting the at least one fluid heater to the pipework and being configured to conduct the heated fluid medium with the pipework.

4. The machine of claim 3, wherein the conduit work comprises:
one or more annular pipe sections disposed about one or more sections of the pipework and defining an annular space therewith; and
one or more conducting lines connected between the at least one fluid heater and the one or more annular pipe sections and conducting the heated fluid medium between the at least one fluid heater and the annular space.

5. The machine of claim 4, comprising one or more manifolds disposed between connections of the one or more conducting lines.

6. The machine of claim 3, further comprising a valve disposed on the pipework between the at least one accumulator and the mold, the valve being operable to open and close communication of the molten coating material therethrough.

7. The machine of claim 3, wherein the at least one fluid heater comprises:
a temperature sensor being configured to measure a temperature of the heated fluid medium;
an electric heating element configured to heat the fluid medium;
a pumping unit configured to pump the fluid medium; and
a controller connected to the temperature sensor, the electric heating element, and the pumping element and being configured to operate the electric heating element and the pumping element based on the measured temperature and the temperature setpoint.

8. The machine of claim 3, further comprising a control unit in communication with the extruder, the at least one accumulator, the mold, and the at least one fluid heater, the control unit being configured to coordinate operation therebetween.

9. The machine of claim 8, further comprising:
one or more temperatures sensors disposed about the pipework and connected to the control unit, the one or more temperatures sensors being configured to measure a temperature associated therewith for the control unit; and/or
one or more pressure sensors disposed about the conduit work and connected to the control unit, the one or more pressure sensors being configured to measure a pressure associated therewith for the control unit.

10. The machine of claim 8, wherein the extruder comprises one or more electric heaters and a feeder, the control unit in communication with the one or more electric heaters and the feeder and being configured to control feeding and melting of the coating material.

11. The machine of claim 8, wherein the at least one accumulator comprises one or more electric heaters and a feeder, the control unit in communication with the one or more electric heaters and the feeder and being configured to control feeding and heating of the molten coating material.

12. The machine of claim 8, wherein the conduit work connects the at least one fluid heater to the extruder and is configured to conduct the heated fluid medium with the extruder, wherein the extruder comprises a feeder, the control unit in communication with the at least one fluid heater and the feeder and being configured to control feeding and melting of the coating material.

13. The machine of claim 12, wherein the at least one fluid heater comprises:
a first of the at least one fluid heater connected by a first of the conduit work to the pipework and being configured to heat the fluid medium to a first of the at least one temperature setpoint; and
a second of the at least one fluid heater connected by a second of the conduit work to the extruder and being configured to heat the fluid medium to a second of the at least one temperature setpoint,
wherein the control unit is configured to separately control the first and second temperatures of the first and second fluid heaters.

14. The machine of claim 8, wherein the conduit work connects the at least one fluid heater to the at least one accumulator and is configured to conduct the heated fluid medium with the at least one accumulator, wherein the at least one accumulator comprises a feeder, the control unit in communication with the at least one fluid heater and the feeder and being configured to control feeding and heating of the molten coating material.

15. The machine of claim 14, wherein the at least one fluid heater comprises:
a first of the at least one fluid heater connected by a first of the conduit work to the pipework and being configured to heat the fluid medium to a first of the at least one temperature setpoint; and
a second of the at least one fluid heater connected by a second of the conduit work to the at least one accumulator and being configured to heat the fluid medium to a second of the at least one temperature setpoint,
wherein the control unit is configured to separately control the first and second temperatures of the first and second fluid heaters.

16. A method of processing an exposed field joint of a pipeline, the method comprising:
melting a coating material in an extruder;
accumulating the melted coating material in at least one accumulator;
injection molding the melted coating material in a mold fit around the exposed field joint;
conducting the melted coating material from the extruder, to the accumulator, and to the mold using pipework; and
maintaining the coating material melted in the pipework by heating a fluid medium and conduiting the heated fluid medium into heat transfer with the pipework.

17. The method of claim 16, wherein conduiting the heated fluid medium into heat transfer with the pipework comprises conducting the heated fluid medium in an annular space of one or more annular pipe sections disposed about one or more sections of the pipework.

18. The method of claim 17, wherein conduiting the heated fluid medium into heat transfer with the pipework comprises distributing the heated fluid medium in a plurality of conducting lines using one or more manifolds disposed between at least one fluid heater and the pipework.

19. The method of claim 16, wherein the heating the fluid medium comprises:
monitoring temperature of the heated fluid medium; and
powering an electric heating element based on the monitored temperature.

20. The method of claim 19, further comprising powering a pump used to pump the heated fluid based on the monitored temperature.

21. The method of claim 16, wherein monitoring temperature of the heated fluid medium comprises monitoring the temperature of the heated fluid medium for one or more of: at least one fluid heater configured to heat the fluid medium; an extruder configured to melt and feed the coating material; at least one accumulator configured to store and expel the molten coating material; and conduit work configured to conduct the heated fluid medium.
